(19) United States
(12) Patent Application Publication
(10) Pub. No.: US 2026/0209017 A1
(43) Pub. Date: Jul. 23, 2026

(54) FORCE IMPULSE TO MEASURE LOAD STABILITY

(71) Applicant: Ocado Innovation Limited, Hatfield (GB)

(72) Inventors: Joseph PETRIE, Jr., Westwood, MA (US); Kurt BILIA, Cambridge, MA (US); Michael REILLY, Winthrop, MA (US)

(21) Appl. No.: 19/142,877

(22) PCT Filed: Dec. 14, 2023
(86) PCT No.: PCT/EP2023/085807

§ 371 Date: Jun. 24, 2025

Related U.S. Application Data
(63) Continuation of application No. 18/147,043, filed on Dec. 28, 2022, now Pat. No. 12,151,924.

(51) Int. Cl. B66F 9/24; B66F 9/06

(52) U.S. Cl. CPC B66F 9/24; B66F 9/063

(57) ABSTRACT

Systems and methods are disclosed for automated analysis of a load of a robotic vehicle. In one example, a method (e.g., a computer-implemented method) includes lifting a load via a lifting mechanism of a robotic vehicle and applying a first pulse of force to the load. The method further includes obtaining, from one or more sensors, first sensor data related to movement of the load responsive to the first pulse of force applied to the load and determining one or more parameters related to the load based on the first sensor data. The method further includes performing one or more actions based on the one or more parameters related to the load. In this manner, the load is analyzed in an automated manner and appropriate action(s) (e.g., not moving the load because it is unstable, restricting acceleration/deceleration of the robotic vehicle while moving the load, etc.) can be taken.

WO

### TECHNICAL FIELD

The present disclosure relates to robotic vehicles and, more specifically, an automated process for determining whether a load to be moved by a robotic vehicle is stable.

### BACKGROUND

Safety in the workplace is of utmost importance. Robotics are increasingly being used in the workplace such as, for example, in factories and warehouses. While robotics bring tremendous advantages, they also introduce safety challenges particularly when the robotics are operating alongside humans.

### SUMMARY

According to a first aspect, there is provided a method of operating a robotic vehicle, the method comprising the steps of: lifting a load via a lifting mechanism of a robotic vehicle; applying a first pulse of force to the load; obtaining, from one or more sensors, first sensor data related to movement of the load responsive to the first pulse of force applied to the load; determining one or more parameters related to the load based on the first sensor data; and performing one or more actions based on the one or more parameters related to the load.

The first pulse of force applied to the load may be either a pulse of lateral force, a pulse of rotational force, or a pulse of combined lateral and rotational forces. The first pulse of force may be applied to the load by the robotic vehicle.

In one example, the one or more parameters related to the load include: a center of gravity of the load; a two-dimensional center of gravity of the load in a lateral plane (X-Z or Y-Z plane) of the load; an amplitude of a response of the load as represented by the first sensor data obtained from the one or more sensors responsive to the first pulse of force; a resonant frequency or natural frequency of the load; a damping factor of the load; one or more parameters indicative of an amount of movement or frequency of movement of the load; a polar moment of inertia of the load; at least one parameter that is based on the first sensor data from a first sensor of the one or more sensors relative to the first sensor data from a second sensor of the one or more sensors; or a combination of any two or more thereof.

In one example, the first pulse of force applied to the load is one of a pulse of lateral force and a pulse of rotational force, and the method further comprises: applying a second pulse of force to the load, the second pulse of force being the other of a pulse of lateral force and a pulse of rotational force; and obtaining second sensor data from the one or more sensors responsive to the second pulse of force applied to the load; wherein determining the one or more parameters related to the load includes determining the one or more parameters related to the load based on both the first sensor data and the second sensor data.

Performing the one or more actions may comprise: determining one or more restrictions or limitations on movement of the robotic vehicle based on the one or more parameters related to the load; and operating in accordance with the one or more restrictions or limitations on movement of the robotic vehicle.

Alternatively, performing the one or more actions may comprise determining whether it is safe for the robotic vehicle to move the load based on the one or more parameters related to the load; and operating in accordance with a result of determining whether it is safe for the robotic vehicle to move the load.

In a further alternative, performing the one or more actions comprises moving the load via the robotic vehicle, and the method further comprises: while moving the load via the robotic vehicle: obtaining third sensor data from the one or more sensors; determining one or more second parameters based on the third sensor data; and adapting either the operation of the robotic vehicle or one or more characteristics of the robotic vehicle based on the one or more second parameters.

Adapting either the operation of the robotic vehicle or the one or more characteristics of the robotic vehicle based on the one or more second parameters may comprise adapting a suspension of the robotic vehicle based on the one or more second parameters.

According to a second aspect, there is provided a robotic vehicle comprising: a lifting mechanism comprising a lifting body and one or more sensors; and a controller associated with the lifting mechanism, the controller configured to, in use,: cause the lifting mechanism to lift a load; cause the robotic vehicle to apply a first pulse of force to the load; obtain, from the one or more sensors, first sensor data related to movement of the load responsive to the first pulse of force applied to the load; determine one or more parameters related to the load based on the first sensor data; and perform one or more actions based on the one or more parameters related to the load.

The one or more sensors may be located on the lifting mechanism. The one or more sensors comprise one or more pressure sensors. In one alternative, the one or more pressure sensors may be implemented within or affixed to the lifting mechanism. The one or more pressure sensors are between a body of the lifting mechanism and a platform on which the load is positioned.

Examples of a robotic vehicle are also disclosed. In one example, a robotic vehicle includes a lifting mechanism including a lifting body and one or more sensors and a controller associated with the lifting mechanism. The controller is configured to cause the lifting mechanism to lift a load, cause the robotic vehicle to apply a first pulse of force to the load, obtain, from the one or more sensors, first sensor data related to movement of the load responsive to the first pulse of force applied to the load, determine one or more parameters related to the load based on the first sensor data, and perform one or more actions based on the one or more parameters related to the load.

### BRIEF DESCRIPTION OF THE DRAWINGS

Examples will be described, by way of example only, with reference to the accompanying figures wherein:

FIG. 1 illustrates one example of a robotic vehicle including an automated load analysis system in accordance with an example of the present disclosure;

FIG. 2 illustrates another example of a robotic vehicle including an automated load analysis system in accordance with an example of the present disclosure;

FIG. 3 is a flow chart that illustrates an automated load analysis procedure in accordance with an example of the present disclosure;

FIG. 4A illustrates one example of the sensor data from three sensors, where the sensors are pressure sensors in accordance with an example of the present disclosure;

FIG. 4B illustrates another example of the sensor data from four sensors in accordance with another example of the present disclosure;

FIG. 4C is an X-Y plot of the center of gravity of a load moving during an impulse in the Y direction determined in accordance with one example of the present disclosure; and

FIG. 5 shows a schematic depiction of a robotic vehicle in accordance with an example of the present disclosure.

Like reference numerals are used in the drawings to denote like elements and features.

### DETAILED DESCRIPTION OF EXAMPLES

Robotic vehicles are increasingly being used in warehouses to lift and carry pallets around the warehouses. One issue is that the loads on the pallets may or may not be safely packed. This may result in accidents in which loads fall while the robotic vehicles are moving the pallets around the warehouse. Such accidents may result in injuries to people working in the warehouse. Such accidents may additionally or alternatively result in lost productivity since these accidents require human intervention to correct (e.g., restack the load onto the pallet) and in some extreme cases may result in complete shutdown of all robotic vehicles in the warehouse (e.g., in a case where an accident blocks a primary route through the warehouse).

One naïve solution to this problem would be to have people verify that loads are stacked properly before the loads are moved by robotic vehicles. However, such a solution would require a significant amount of workers and time, particularly in large warehouses of the type in which such robotic vehicles are normally used. In addition, people are not always reliable and in many situations it may be difficult for a person to tell if a load is safely stacked on a pallet. For instance, from the person's perspective, the load may appear to be packed safely but, due to factors that are imperceptible to the person (e.g., differences in weight or density of items stacked on the pallet or the load may be top-heavy), the load may actually be unstable. As such, accidents may still occur even though the loads have been verified by a person before being moved.

Systems and methods are disclosed herein for performing an automated analysis of a load carried (e.g., on a platform such as, e.g., a pallet or table) by a robotic vehicle before the load is moved by the robotic vehicle. This analysis is, in one example, performed by a corresponding automated load analysis system incorporated within or onto the robotic vehicle. In another example, this analysis is performed by an external system that is, e.g., separate from the robotic vehicle (e.g., the stacked load (e.g., on a pallet) is tested by a separate automated load analysis system) prior to being loaded onto or picked-up by the robotic vehicle. As a result of the automated analysis, one or more actions are performed by the robotic vehicle or the automated load analysis system such as, e.g., deciding to place one or more restrictions on the movement (e.g., one or more restrictions on linear and/or angular velocity and/or acceleration) of the robotic vehicle while moving the load, adapting one or more characteristics of the robotic vehicle (e.g., adapting suspension), or the like.

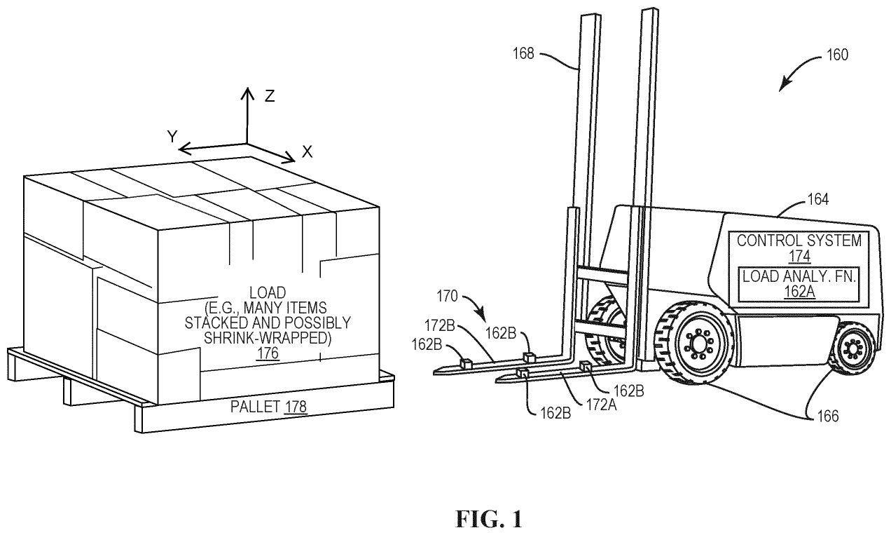

FIG. 1 illustrates one example of a robotic vehicle 160 including an automated load analysis system 162 in accordance with an example of the present disclosure. Note that while the automated load analysis system 162 is included within, or as part of, the robotic vehicle 160 in this example, the automated load analysis system 162 may alternatively be a separate system that is attached or affixed to the robotic vehicle 160. The robotic vehicle 160 includes a vehicle body 164 including various electrical and mechanical components (e.g., a motor(s), a drivetrain, axles, suspension, etc.), wheels 166, a lifting mechanism 168 which in this particular example is a forklift mechanism including a fork 170 including tines 172A and 172B, and a control system 174 that controls the overall operation of the robotic vehicle 160. In some examples, the fork 170 may have more or less than two tines. Additionally or alternatively, the fork 170 (or one or more of its tines) may be retractable (e.g., into the forklift mechanism or the vehicle body 164) or otherwise reconfigurable (e.g., detachable) or relocatable relative to the vehicle body 164 (e.g., to effect different placements of a pallet 178 relative to the vehicle body 164). In some examples, the components and wheels of the vehicle body 164 may be arranged and/or configured such that the robotic vehicle 160 is a differential wheeled robot. For example, the robotic vehicle 160 may have two drive wheels on opposing sides of the vehicle body 164. The drive wheels may be driven by a differential drive controller and the robotic vehicle 160 may have castor wheels for support.

The automated load analysis system 162 includes a load analysis function 162A and sensors 162B for sensing and analyzing movement of a load 176 stacked on the pallet 178 that is carried by the robotic vehicle 160 via the tines 172A and 172B of the fork 170 of the lifting mechanism 168. While the automated load analysis system 162 and thus the sensors 162B are part of the robotic vehicle 160 in this example, the sensors 162B may alternatively be separate from the robotic vehicle 160 (e.g., attached to or integrated into the pallet 178 where the sensors 162B are communicatively coupled to the robotic vehicle 160 via any suitable wireless connection or electrical contact. Note that the load 176 preferably includes multiple items that are stacked on the pallet 178. The load analysis function 162A is preferably implemented in software that is executed by processing circuitry (e.g., one or more Central Processing Units (CPUs), microcontrollers, Digital Signal Processors (DSPs), Application Specific Integrated Circuits (ASICs), Field Programmable Gate Arrays (FPGAs), and/or the like) to perform the operations of the load analysis function 162A described herein. In this illustrated example, the load analysis function 162A is implemented within the control system 174 but is not limited thereto.

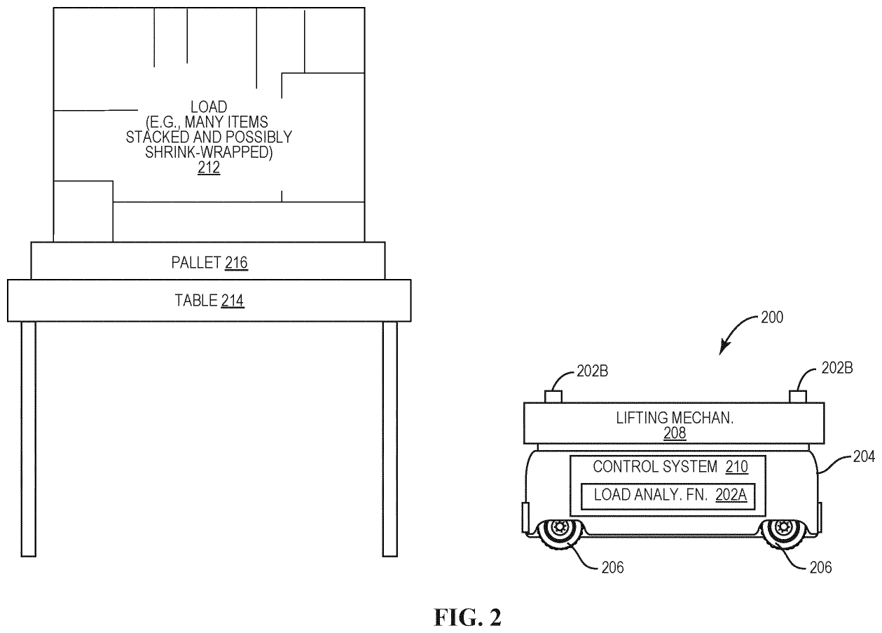

Furthermore, in this example, the sensors 162B are positioned on a surface of the tines 172A and 172B between the tines 172A and 172B and the pallet 178 such that the pallet 178 and thus the load 176 can be sensed via the sensors 162B. However, the sensors 162B may be otherwise positioned on the robotic vehicle 160 as long as the sensors 162B are able to sense movement of the load 176 in response to a force pulse applied to the load 176 as described herein. For instance, the sensors 162B may be, or include, sensors on or otherwise associated to the wheels 166 of the robotic vehicle 160. The sensors 162B may be, for example, pressure sensors that output data indicative of the pressure sensed by the sensors 162B, strain gauges on the tines 172A and 172B of the fork 170 of the lifting mechanism 168, or the like. The sensors 162B may also include one or more sensors for sensing whether the load 176 is wrapped (e.g., in a plastic wrap or film) or not. The sensors 162B are coupled to the load analysis function 162A such that the output data from the sensors 162B is received by the load analysis function 162A where this data is used to perform an automated analysis of the load 176, as described below in detail. FIG. 2 illustrates another example of a robotic vehicle 200 including an automated load analysis system 202 in accordance with an example of the present disclosure. Note that while the automated load analysis system 202 is included within, or as part of, the robotic vehicle 200 in this example, the automated load analysis system 202 may alternatively be a separate system that is attached or affixed to the robotic vehicle 200. The robotic vehicle 200 includes a vehicle body 204 including various electrical and mechanical components (e.g., a motor(s), a drivetrain, axles, suspension, etc.), wheels 206, a lifting mechanism 208, and a control system 210 that controls the overall operation of the robotic vehicle 200. In this example, the robotic vehicle 200 carries a load 212 by moving under a table 214 on which the load 212 or on which a pallet 216 carrying the load 212 is placed and then lifting the table 214 and thus the load 212 via the lifting mechanism 208. The lifting mechanism 208 may be any suitable lifting mechanism such as, for example, a hydraulic lift. Note that the load 212 preferably includes multiple items that are stacked on a top surface of the table 214 or on the pallet 216. The automated load analysis system 202 includes a load analysis function 202A and sensors 202B for sensing and analyzing movement of the load 212 that is carried by the robotic vehicle 200, e.g., via the lifting mechanism 208. In some examples, the load 212 may be carried or otherwise directly supported by the vehicle body 204.

Additionally or alternatively, the lifting mechanism 208 may be configured such that it only carries or otherwise directly supports the load 212 for the purpose of placing or removing it from the vehicle body 204. Additionally or alternatively, while the automated load analysis system 202 and thus the sensors 202B are part of the robotic vehicle 200 in this example, the sensors 202B may alternatively be separate from the robotic vehicle 200 (e.g., attached to or integrated into the table 214 or pallet 216 where the sensors 202B are communicatively coupled to the robotic vehicle 200 via any suitable wireless connection or electrical contact. The load analysis function 202A is preferably implemented in software that is executed by processing circuitry (e.g., one or more CPUs, ASICS, FPGAs, and/or the like) to perform the operations of the load analysis function 202A described herein. In this illustrated example, the load analysis function 202A is implemented within the control system 210 but is not limited thereto.

Furthermore, in this example, the sensors 202B are positioned on a surface of the lifting mechanism 208 between a surface of the lifting mechanism 208 and a bottom of the table 214 such that the load 212 can be sensed via the sensors 202B. However, the sensors 202B may be otherwise positioned on the robotic vehicle 200 as long as the sensors 202B are able to sense movement of the load 212 in response to a force pulse applied to the load 212 as described herein. For instance, the sensors 202B may be, or include, sensors on or otherwise associated to the wheels 206 of the robotic vehicle 200. The sensors 202B may be, for example, pressure sensors that output data indicative of the pressure sensed by the sensors 202B. The sensors 202B are coupled to the load analysis function 202A such that the output data from the sensors 202B is received by the load analysis function 202A where this data is used to perform an automated analysis of the load 212, as described below in detail. The sensors 202B may be selected to provide sensor data required to observe and/or control one or more modes of motion of the robotic vehicle 160 and/or the load 212 (e.g., sloshing from side to side, bouncing up and down, twisting back and forth, etc.).

Note that the robotic vehicles 160 and 200 of FIGS. 1 and 2 respectively are only examples. Other types of robotic vehicles may be used in combination with an automated load analysis system, such as the automated load analysis system 162 or 202, to analyze a load carried by the robotic vehicle and perform one or more actions based on a result(s) of the analysis.

Also note that in the example examples of FIGS. 1 and 2, while the automated load analysis systems 162 and 202 are included as part of the robotic vehicles 160 and 200 where, as discussed below, the robotic vehicles 160 and 200 apply a force pulse(s) to the load 176 and 212 for the automated load analysis, the present disclosure is not limited thereto. In an alternative example, the automated load analysis system 162 or 202 is part of a separate system where this separate system includes a mechanism for applying a force pulse(s) to the load 176 or 212 for automated load analysis prior to placing the load 176 or 212 (or the pallet 178 or 216 on which the load 176 or 212 is stacked) onto the robotic vehicle 160 or 200.

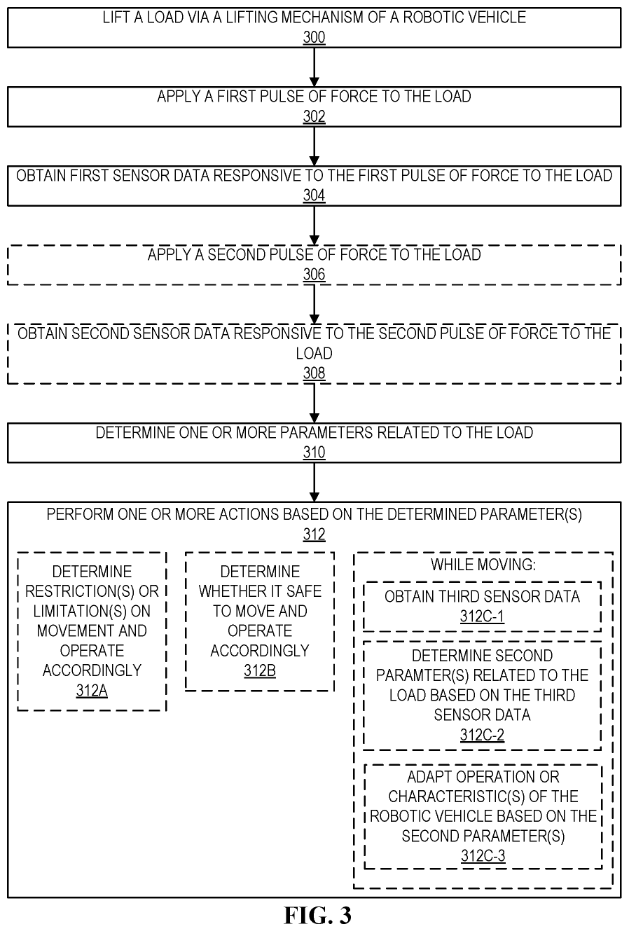

FIG. 3 is a flow chart that illustrates an automated load analysis procedure in accordance with an example of the present disclosure. In the following description, references are made to the robotic vehicles 160 and 200 and the automated load analysis systems 162 and 202 of FIGS. 1 and 2, respectively, for clarity and ease of discussion. Note, however, that this procedure is not limited to being performed by the example systems of FIGS. 1 and 2. As illustrated in FIG. 3, the load 176 or 212 is first lifted by the lifting mechanism 168 or 208 of the robotic vehicle 160 or 200 (step 300). The robotic vehicle 160 or 200 applies a first pulse of force to the load 176 or 212 (step 302). Preferably, the first pulse of force is such that it approximates (e.g., can be treated as) an impulse (e.g., as might be characterized using a Dirac delta function). The first pulse of force may be a lateral pulse of force, a rotational pulse of force, or a combination thereof. For example, the first pulse of force may be applied to the load 176 or 212 by the robotic vehicle 160 or 200 accelerating or decelerating. This acceleration or deceleration may be a known (e.g., predefined or configured) amount of acceleration or deceleration. The acceleration or deceleration may be a known (e.g., predefined or configured) starting velocity and/or for a known amount of time (e.g., predefined or configured). As another example, the first pulse of force may be applied to the load 176 or 212 by the robotic vehicle 160 or 200 rotating, e.g., while otherwise at rest, while moving at a constant velocity, or while accelerating or decelerating at a known rate). The acceleration or deceleration may be sudden (e.g., to better approximate an impulse).

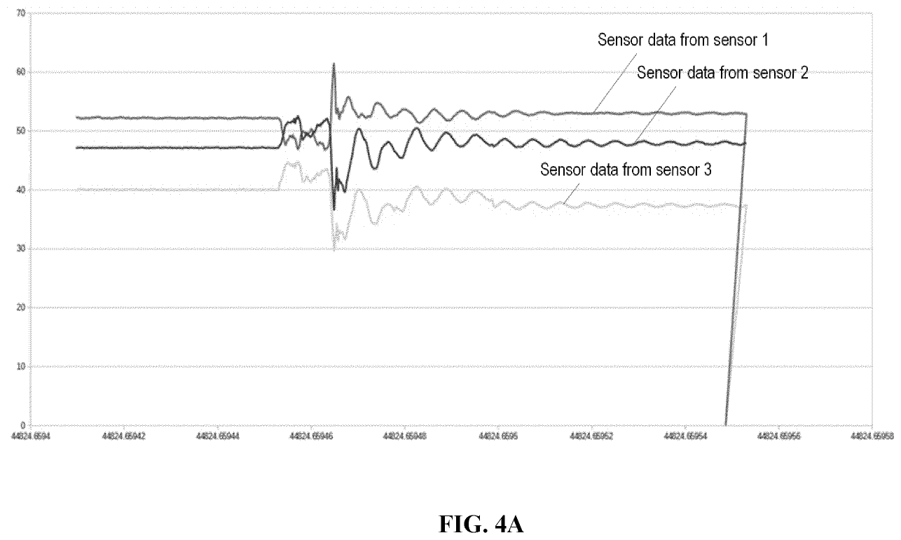

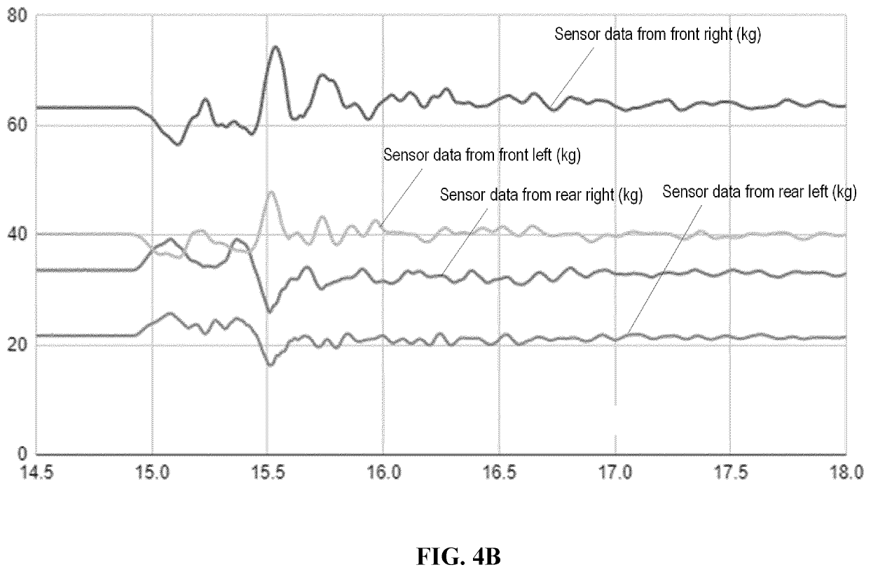

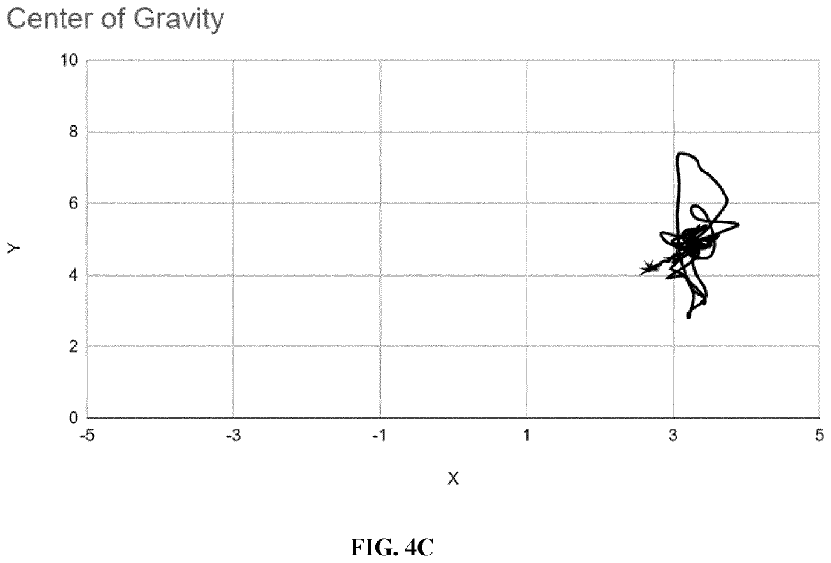

First sensor data is obtained, e.g., by the load analysis function 162A or 202A from the sensors 162B or 202B, responsive to the first pulse of force applied to the load 176 or 212 (step 304). In other words, the first sensor data is data obtained from the sensors 162B or 202B during a time window in which the load 176 or 212 moves in response to applying the first pulse of force. This period of time may, for example, start before, at, or just after applying the first pulse of force and continue over some duration of time in which the load 176 or 212 moves as a result of the first pulse of force. FIG. 4A is a time-based graph that illustrates one example of the sensor data from three sensors, where the sensors are pressure sensors. As can be seen in FIG. 4A, the sensor data from each sensor provides a series of sensor readings over time that form a waveform that is indicative of the movement of the load 176 or 212 relative to the sensor in response to the first pulse of force. FIG. 4B illustrates another example of sensor data from four sensors, i.e. a front right sensor, a front left sensor, a rear right sensor, and a rear left sensor, where the sensors are pressure sensors. As can be seen in FIG. 4B, the sensor data from each sensor provides a series of sensor readings over time that form a waveform that is indicative of the movement of the load 176 or 212 relative to the sensor in response to the first pulse of force. FIG. 4C illustrates an x-y plot of the center of gravity of the load 176 or 212 moving during an impulse in the Y direction, which is derived from the sensor data.

Optionally, the robotic vehicle 160 or 200 applies a second pulse of force to the load 176 or 212 (step 306). Preferably, the second pulse of force is such that it approximates an impulse. The second pulse of force may be a lateral pulse of force, a rotational pulse of force, or a combination thereof. The second pulse force is preferably different in type than the first pulse of force. For example, if the first pulse of force is a lateral pulse of force, the second pulse of force may be a rotational pulse of force, or vice versa. Second sensor data is obtained, e.g., by the load analysis function 162A or 202A from the sensors 162B or 202B, responsive to the second pulse of force applied to the load 176 or 212 (step 308). In other words, the second sensor data is data obtained from the sensors 162B or 202B during a time window in which the load 176 or 212 moves in response to applying the second pulse of force. This period of time may, for example, start before, at, or just after applying the second pulse of force and continue over some duration of time in which the load 176 or 212 moves as a result of the first pulse of force.

The load analysis function 162A or 202A determines one or more parameters related to the load 176 or 212 based on the first sensor data and optionally (i.e., if steps 306 and 308 are performed) the second sensor data (step 310). When determining the one or more parameters related to the load 176 or 212, the load analysis function 162A or 202A may further consider the known first pulse of force and, if steps 306 and 308 are performed, the second pulse of force. The one or more parameters may be any parameters related to the load 176 or 212 that are indicative of one or more characteristics of the load 176 or 212 that can be derived from the first sensor data and optionally the known first pulse of force and still further, if steps 306 and 308 are performed, the second sensor data and optionally the known second pulse of force. The one or more parameters are also any such parameter(s) that can be used to determine whether the load 176 or 212 is stable or at least sufficiently stable for the robotic vehicle 160 or 200 to move the load 176 or 212 or move the load 176 or 212 in a restricted manner (e.g., with one or more restrictions such as, e.g., a restriction on the rate of acceleration and/or deceleration, a restriction on speed, a restriction on rotational speed, a restriction on rotational acceleration, or the like). Some examples of the one or more parameters related to the load 176 or 212 determined in step 310 include, but are not limited to:
center of gravity of the load 176 or 212 (e.g., two-dimensional central of gravity in a lateral plane (X-Z or Y-Z plane) of the load 176 or 212);
   the two-dimensional center of gravity of the load 176 or 212 in the X-Z plane may be determined based on the sensor data by using the center of gravity data to determine a point in the X-Z plane around which the load 176 or 212 moves. Note that the two-dimensional center of gravity in the X-Z plane may also be determined from obtaining data from the sensors 162B or 202B while lifting the load 176 or 212.
an amplitude of a response of the load 176 or 212 as represented by the sensor data obtained from the one or more sensors 162B or 202B responsive to the first pulse of force and/or optionally the second pulse of force;
   This may include the amplitude or maximum amplitude of the sensor data from any one sensor, a combination (e.g., average) of the amplitude or maximum amplitude of the sensor data from all of the sensors, or the like.
a resonant frequency or natural frequency of the load 176 or 212;
   The resonant frequency of the load 176 or 212 may be computed from the sensor data by observing the frequency components of the sensor data. For instance, the frequency and amplitude of the waveform provided by the sensor data of a sensor may be used to determine a damped resonant frequency of the load 176 or 212 from which the resonant frequency of the load 176 or 212 can be determined.
a damping factor, or ratio, of the load 176 or 212;
   The damping factor, or ratio, may be computed from the amplitude of the sensor data from any one or a combination of the sensors 162B or 202B over time.
an amount of movement of the load 176 or 212 in response to the first pulse of force and/or the second pulse of force (e.g., an amount of side-to-side movement of the load 176 or 212 in response to the first/second pulse of force, an amount of up-and-down movement of the load 176 or 212 in response to the first/second pulse of force, an amount of front-to-back movement of the load 176 or 212 in response to the first/second pulse of force, or the like), where the “amount of movement” may be determined based on the amplitudes of the sensor data received from the sensors 162B or 202B and may possibly be normalized based on an amplitude of the first/second pulse of force;
a frequency of movement of the load 176 or 212 (e.g., a frequency at which the load 176 or 212 moves from side-to-side in response to the first/second pulse of force, a frequency at which the load 176 or 212 moves up-and-down in response to the first/second pulse of force, a frequency at which the load 176 or 212 moves front-to-back in response to the first/second pulse of force, or the like);
a polar moment of inertia of the load 176 or 212 or possibly more than one polar moment of inertia (e.g., both horizontal and vertical polar moments of inertia);
one or more parameters based on the sensor data from the sensors 162B or 202B relative to one another or a comparison of the sensor data from the different sensors 162B or 202B (e.g., an amount of time between a peak in the amplitude of one sensor and a peak in the amplitude of another sensor, a phase difference between the sensor data from one sensor and the sensor data from another sensor, an amplitude difference between the sensor data from one sensor and the sensor data from another sensor, etc.);
   Note that the relative amplitudes and/or phases of the sensor data from different sensors may be used to compute various parameters. For example, considering a load on a pallet with a grid of four sensors-two on each of the two tines of a fork on a forklift, then the amplitudes and phases of the sensor data from the four sensors can be used to determine an axis in the lateral plane (i.e., the X-Z plane) about which the load 176 or 212 sways back-and-forth and well as the magnitude of the sway in either direction.
a parameter(s) related to (e.g., measuring) one or more desired modes of motion of the load 176 or 212 (e.g., sloshing from side-to-side, bouncing up-and-down, twisting back-and-forth, etc.);
a parameter indicative of whether the load 176 or 212 is wrapped (e.g., in a plastic wrap or film) or not.

Note that the type of force(s) pulse applied and/or the number of sensors 162B or 202B and/or the arrangement or positioning of the sensors 162B or 202B may vary depending on the particular parameter(s) to be determined as different parameters may require different types of force pulses and/or different numbers of sensors and/or different arrangements of the sensors.

Next, one or more actions are performed based on the one or more parameters related to the load 176 or 212 determined in step 310 (step 312). In one example, the one or more actions include determining one or more restrictions or limitations on movement of the robotic vehicle 160 or 200 based on the one or more parameters related to the load 176 or 212 and operating the robotic vehicle 160 or 200 in accordance with the one or more restrictions (step 312A). The one or more restrictions may include any one or more of the following:
a restriction or limitation on a linear speed of movement of the robotic vehicle 160 or 200;
a restriction or limitation on a linear acceleration of the robotic vehicle 160 or 200;
a restriction or limitation on a linear deceleration of the robotic vehicle 160 or 200;
a restriction or limitation on a rotational speed of movement of the robotic vehicle 160 or 200;
a restriction or limitation on a rotational acceleration of the robotic vehicle 160 or 200;
a restriction or limitation on a rotational deceleration of the robotic vehicle 160 or 200; or
a combination of any two or more of the restrictions above.

In another example, the one or more actions include determining whether it is safe for the robotic vehicle 160 or 200 to move the load 176 or 212 based on the one or more parameters related to the load 176 or 212 and operating the robotic vehicle 160 or 200 in accordance with a result of determining whether it is safe for the robotic vehicle 160 or 200 to move the load 176 or 212 (step 312B).

In another example, the one or more actions performed in step 312 include, while moving the load 176 or 212 via the robotic vehicle 160 or 200, obtaining third sensor data from the sensors 162B or 202B (step 312C-1), determining one or more second parameters related to the load 176 or 212 based on the third sensor data (step 312C-2), and adapting either operation of the robotic vehicle 160 or 200 or one or more characteristics of the robotic vehicle 160 or 200 based on the one or more second parameters (step 312C-3). The one or more second parameters may include an amount of movement of the load or 212 (e.g., amount of movement in an up-and-down direction based on the amplitude of sensor data), dominant frequency or frequencies of movement of the load or 212 (e.g., the dominant frequency or frequencies of oscillation in the sensor data), or any other of the parameters described above with respect to the one or more first parameters. In one example, the adaptation includes adaptation of the operation of the robotic vehicle 160 or 200 based on the one or more second parameters, where this adaptation includes any one or more of the following:
adapting a restriction or limitation on a linear speed of movement of the robotic vehicle 160 or 200;
adapting a restriction or limitation on a linear acceleration of the robotic vehicle 160 or 200;
adapting a restriction or limitation on a linear deceleration of the robotic vehicle 160 or 200;
adapting a restriction or limitation on a rotational speed of movement of the robotic vehicle 160 or 200;
adapting a restriction or limitation on a rotational acceleration of the robotic vehicle 160 or 200;
adapting a restriction or limitation on a rotational deceleration of the robotic vehicle 160 or 200;
adapting any such restriction or limitation on the movement of the robotic vehicle 160 or 200 in order to prevent or mitigate the cause of the vehicle being driven at or near its determined resonant or natural frequency (e.g., preventing a certain speed over a floor with regularly-spaced speed bumps);
adapting a restriction or limitation on the movement of the robotic vehicle 160 or 200 such that the vehicle must then have a speed above a determined minimum speed (e.g., to address a floor with regularly-spaced speed bumps);
adapting a restriction or limitation on the movement of the robotic vehicle 160 or 200 such that the restriction or limitation only applies to specific locations (e.g., a specific aisle in a warehouse); or
a combination of any two or more of the above adaptations.

In another example, the adaptation of the operation of the robotic vehicle 160 or 200 may include stopping the robotic vehicle 160 or 200. In yet another example, the adaptation of the operation of the robotic vehicle 160 or 200 may include controlling the robotic vehicle 160 or 200 such that the robotic vehicle 160 or 200 moves to a safe place (e.g., one of a set of predefined or preconfigured safe stopping places) and stops at the safe place. In another example, the adaptation includes adaptation of one or more characteristics of the robotic vehicle 160 or 200 based on the one or more second parameters, where the adapted characteristics may include, e.g., one or more characteristics of a suspension system of the robotic vehicle 160 or 200 where the suspension system is thereby adapted in a manner that stabilizes the load 176 or 212 if the load 176 or 212 is determined to be unstable based on the second parameter(s).

Examples of the present disclosure may be utilized in any environment in which a robotic vehicle is to move a load. For example, such a robotic vehicle may be used when transporting pallets of goods to be inducted into an automated storage and retrieval system such as is disclosed in WO201/5019055. In a further example, such a robotic vehicle may be used alongside other autonomous vehicles such as those disclosed in US2018/006580.

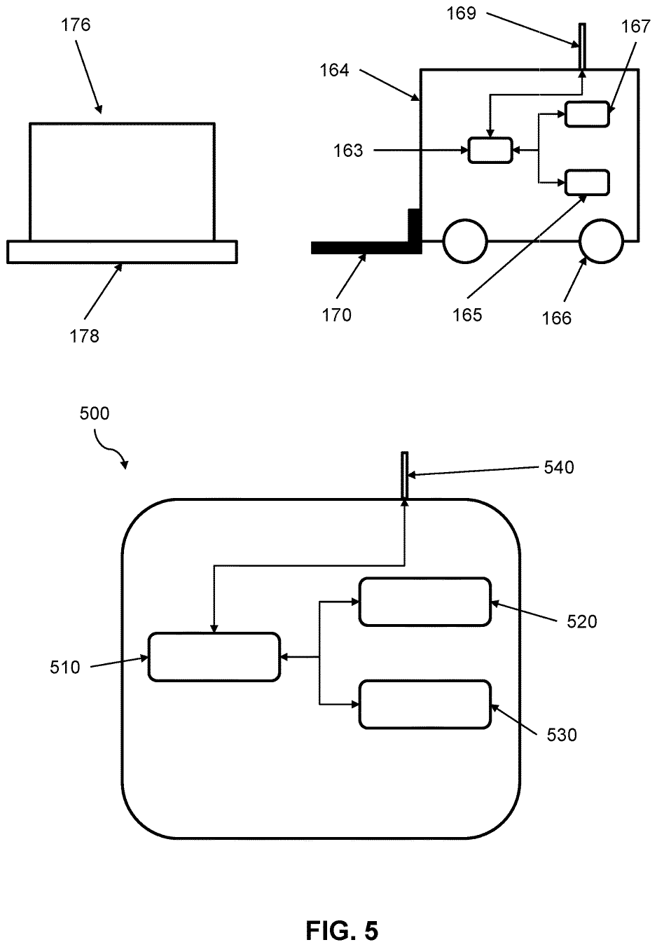

FIG. 5 shows a schematic depiction of a robotic vehicle 160 in accordance with an example of the present disclosure described above with reference to FIG. 1. It should be understood that the following discussion is equally applicable to the robotic vehicle 200 described above with reference to FIG. 2. As discussed above, the robotic vehicle comprises vehicle body 164, wheels 166 and fork 170. The robotic vehicle further comprises processor unit 163, which is communicatively coupled to random access memory (RAM) 165 and non-volatile data storage unit 167. The processor unit is able to execute computer code stored in the non-volatile data storage unit 167 in order to control the operations of the robotic vehicle, including, for example, the activation of the forklift, the drive wheels, the control system 174 (not shown in FIG. 5), etc. The robotic vehicle further comprises a wireless communication interface 169 such that the robotic vehicle may receive data from, and transmit data to, a computing system 500. The wireless communication interface 169 may comprise a WiFi interface, or other similar wireless interface such as, for example, LTE or 5G.

The computing system 500 comprises a processing unit 510, which is communicatively coupled to random access memory (RAM) 520 and non-volatile data storage 530. The non-volatile data storage stores an operating system, one or more application programs and data which is to be accessed during the operation of the computing system. The computing system further comprises a wireless interface such that the computing system is able to transmit data to, and receive data from, one or more active robotic vehicles that are active within an environment, for example a warehouse. In an example, the computing system stores data relating to the product items stored at respective locations within the warehouse. The computing system may, for example, send an instruction to one of the robotic vehicles to move to a first location, retrieve a pallet from that location, move to a second location and then deposit the pallet at the second location. It should be understood that the computing system may comprise further elements not shown in FIG. 5 such as, for example, a display screen and user interface elements that enable an operator to interact with the computing system, view data held by the computing system, etc. The computing system may additionally comprise a wide area network (WAN) interface to enable the computing system to connect to the internet in order to communicate with other computer systems, for example computing systems in further warehouses, centralized systems, computer systems of suppliers, etc. It should be understood that the computer system may be instantiated as a server which is located at a warehouse, as a server located elsewhere or as a number of processes executed on a cloud computing platform.

It should be understood that the present disclosure may be implemented in computer code which is executed by the processor unit. Such computer code may be provided on physical media, for example, DVD, CD-ROM, USB memory stick, etc. or may be made available for download and installation.

The methods and systems described herein may transform physical and/or or intangible items from one state to another. The methods and systems described herein may also transform data representing physical and/or intangible items from one state to another, such as from usage data to a normalized usage dataset.

According to an aspect, there is provided systems and methods for automated analysis of a load of a robotic vehicle. In one example, a method (e.g., a computer-implemented method) includes lifting a load via a lifting mechanism of a robotic vehicle and applying a first pulse of force to the load. The method further includes obtaining, from one or more sensors, first sensor data related to movement of the load responsive to the first pulse of force applied to the load and determining one or more parameters related to the load based on the first sensor data. The method further includes performing one or more actions based on the one or more parameters related to the load. In this manner, the load is analyzed in an automated manner and appropriate action(s) (e.g., not moving the load because it is unstable, restricting acceleration/deceleration of the robotic vehicle while moving the load, etc.) can be taken.

1. A method of operating a robotic vehicle, the method comprising the steps of:
lifting a load via a lifting mechanism of a robotic vehicle;
applying a first pulse of force to the load;
obtaining, from one or more sensors, first sensor data related to movement of the load responsive to the first pulse of force applied to the load;
determining one or more parameters related to the load based on the first sensor data; and
performing one or more actions based on the one or more parameters related to the load.

2. A method according to claim 1, wherein the first pulse of force applied to the load is either a pulse of lateral force, a pulse of rotational force, or a pulse of combined lateral and rotational forces.

3. A method according to claim 1, wherein the first pulse of force is applied to the load by the robotic vehicle.

4. A method according to claim 1 wherein the first pulse of force applied to the load is one of a pulse of lateral force and a pulse of rotational force, and the method further comprises:
applying a second pulse of force to the load, the second pulse of force being the other of a pulse of lateral force and a pulse of rotational force; and
obtaining second sensor data from the one or more sensors responsive to the second pulse of force applied to the load;
wherein determining the one or more parameters related to the load includes determining the one or more parameters related to the load based on both the first sensor data and the second sensor data.

5. A method according to claim 1, wherein performing the one or more actions comprises:
determining one or more restrictions or limitations on movement of the robotic vehicle based on the one or more parameters related to the load; and
operating in accordance with the one or more restrictions or limitations on movement of the robotic vehicle.

6. A method according to claim 1, wherein performing the one or more actions comprises:
determining whether it is safe for the robotic vehicle to move the load based on the one or more parameters related to the load; and
operating in accordance with a result of determining whether it is safe for the robotic vehicle to move the load.

7. A method according to claim 1, wherein performing the one or more actions comprises moving the load via the robotic vehicle, and the method further comprises:
while moving the load via the robotic vehicle:
obtaining third sensor data from the one or more sensors;
determining one or more second parameters based on the third sensor data; and
adapting either the operation of the robotic vehicle or one or more characteristics of the robotic vehicle based on the one or more second parameters.

8. A method according to claim 7, wherein adapting either the operation of the robotic vehicle or the one or more characteristics of the robotic vehicle based on the one or more second parameters comprises adapting a suspension of the robotic vehicle based on the one or more second parameters.

9. A robotic vehicle comprising:
a lifting mechanism comprising a lifting body and one or more sensors; and
a controller associated with the lifting mechanism, the controller configured to, in use,:
cause the lifting mechanism to lift a load;
cause the robotic vehicle to apply a first pulse of force to the load;
obtain, from the one or more sensors, first sensor data related to movement of the load responsive to the first pulse of force applied to the load;
determine one or more parameters related to the load based on the first sensor data; and
perform one or more actions based on the one or more parameters related to the load.

10. A robotic vehicle according to claim 9, wherein the one or more sensors are located on the lifting mechanism.

11. A robotic vehicle according to claim 10, wherein the one or more sensors comprise one or more pressure sensors implemented within or affixed to the lifting mechanism.

12. A robotic vehicle according to claim 11, wherein the one or more pressure sensors are between a body of the lifting mechanism and a platform on which the load is positioned.
